(19) United States
(12) Patent Application Publication
(10) Pub. No.: US 2016/0130078 A1
(43) Pub. Date: May 12, 2016

(54) Bladder Systems for Dual Use of Truck Tanks

(71) Applicant: i3 Capital Partners, LLC, Evergreen, CO (US)

(72) Inventor: Patric N. Galvin, Evergreen, CO (US)

(73) Assignee: i3 Capital Partners, LLC, Evergreen, CO (US)

(21) Appl. No.: 14/848,854

(22) Filed: Sep. 9, 2015

Related U.S. Application Data
(60) Provisional application No. 62/076,080, filed on Nov. 6, 2014.

(51) Int. Cl. B65D 88/12; B60P 3/24; B65D 90/04; B60P 3/22; B65D 88/54

(52) U.S. Cl. CPC B65D 88/12; B60P 3/2205; B65D 88/54; B65D 90/046; B60P 3/246

(57) ABSTRACT

A system and method for reducing the number of tank trips needed to haul products to and from a work site. An example bladder system for a tank truck is presented wherein the tank can be filled for example with clean water for transport to the work site. Once emptied the bladder within the tanker can be filled with for example used and/or contaminated water for transport to a disposal/treatment facility.

### CROSS REFERENCE TO RELATED APPLICATIONS

This application claims priority to U.S. Prov. App. No. 62/076080 filed Nov. 6, 2014.

### FIELD OF INVENTION

The invention relates to the field of transport and storage of bulk materials and reduction in expense of transport of such materials.

### BACKGROUND OF THE INVENTION

In general, it is not uncommon for transport costs to account for 10% of the total cost of a product. Transport costs are a monetary measure of what the transport provider must pay to produce transportation services. They come as fixed (infrastructure) and variable (operating) costs, depending on a variety of conditions related to geography, infrastructure, administrative barriers, energy, and on how freight is carried. Transport activities are large consumers of energy, especially oil. About 60% of all the global oil consumption is attributed to transport activities. Transport typically account for about 25% of all the energy consumption of an economy. In 1995 it was estimated that transportation costs per ton-mile were 1 cent per dollar for maritime transport, 3 cents per dollar for rail transport, and 25 cents per dollar for truck transport.

In particular for hydraulic fracturing, or fracking, transportation needs especially for fresh and flowback water are quite high. In fracking a mixture of water, proppants, and chemicals is pumped into the rock or coal formation. Used fracturing fluids that return to the surface are often referred to as flowback, and these wastes are typically stored in open pits or tanks at the well site prior to transport to a disposal facility. In 2010, the U.S. Environmental Protection Agency estimated that 70 to 140 billion gallons of water are used to fracture 35,000 wells in the United States each year. Fracture treatments in coalbed methane wells use from 50,000 to 350,000 gallons of water per well, while deeper horizontal shale wells can use anywhere from 2 to 10 million gallons of water to fracture a single well.

### BRIEF DESCRIPTION OF THE DRAWINGS

FIG. 1 (Prior Art) is a schematic view of the prior art apparatus and system of water transport at a fracking site.

FIG. 2A and FIG. 2B are side cutaway views of a bladder in use.

FIGS. 3A and 3B illustrate alternate designs for the bladder apparatus shown in FIGS. 2A, 2B.

FIG. 4 is a side cutaway view of an alternate design with an additional bladder to be used in conjunction with a first bladder.

FIGS. 5A, 5B, and 5C are transverse cross sections of a tank with an example bladder and bladder holder system.

FIGS. 6A, 6B are side cutaway views of another embodiment of a bladder apparatus.

FIGS. 7A and 7B show two example bladder holders.

FIG. 8 is a side cutaway view for installation of the bladder.

### SUMMARY

A typical fracking site uses two types of trucks. The clean water truck arrives at the drill site to dump water into a processing station to prepare for the fracking injection. The flowback water truck is filled with the flowback water that comes out of the well and is driven to a remote treatment facility. Thus, each truck has to make a dead head empty run after each delivery.

What is needed in the art is a single truck with a bladder means to first fill the tank with clean water. Then it is necessary to refill the empty “clean water” truck with flowback water, wherein no contamination occurs to the clean water when it is filled again.

The present invention provides several examples of bladders designed to fit inside a tanker truck. All the examples allow a separation of the clean water bladder walls from the flowback water bladder walls. Thus, the number of trucks needed is halved, and the number of transit runs is also halved.

### DETAILED DESCRIPTION OF THE INVENTION

For fracking, it has been estimated that the transportation of two to five million gallons of water (fresh or waste water) requires about 1,000 to 1,400 truck trips. In addition fresh water delivered to a drilling site costs between 10 and 14 cents per gallon or about $250 per trip wherein only 20 percent of that cost is attributed to the cost of the water. Water transport to and from fracking sites alone can cost upward of $400,000 per fracturing attempt. In addition to expense, the transport traffic of so much water may create localized air quality, safety, and road repair issues.

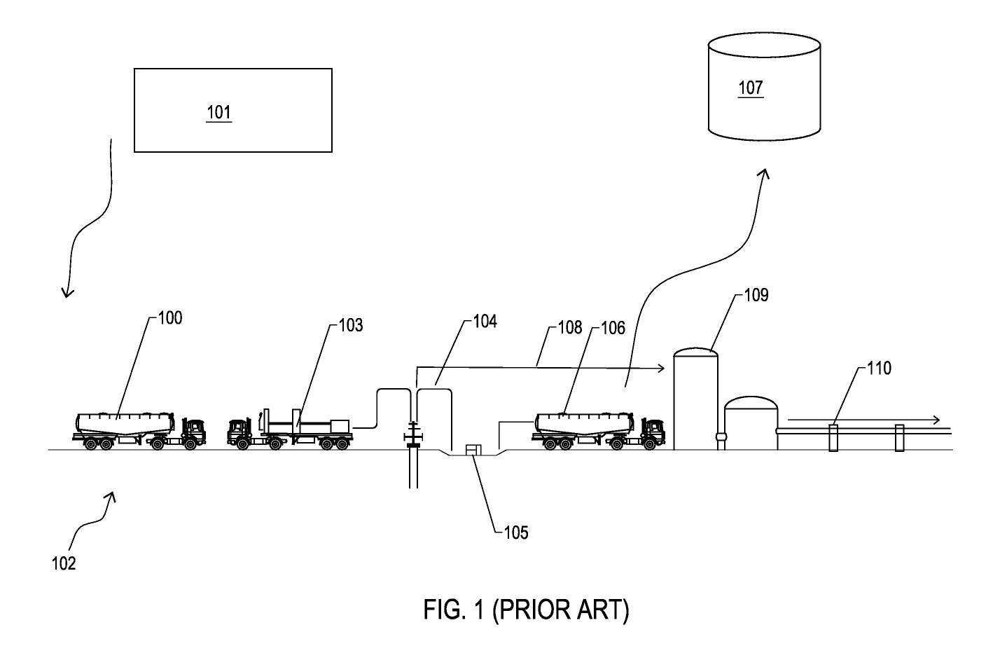

FIG. 1 illustrates the prior art apparatus and system of water transport at a fracking site. As many as a thousand trucks 100 bring fresh water from a water source 101 to the fracking site 102. These tanker/pumper trucks 100 carry a total of 5 M gallons of fresh water to a single well. There may be eight to ten wells at a fracking site. Freshwater, sand, and other chemicals are pumped into the well 103. Flowwater is forced back up out of the well 104 and into a holding pit 105. A different tanker/pumper truck 106 vacuums flowwater from the pit to transport the flowwater to a disposal/treatment plant 107. In addition to the flowwater, natural gas flows out of the well 108, and into storage tanks 109. Pipelines transport the natural gas for processing 110. Different trucks are used for the fresh water 100 and contaminated flowwater 106 such that as many as two thousand trucks may be needed to supply freshwater and take away flowwater for a single well.

It would be advantageous to provide an apparatus that reduces the number of transport vehicles needed to for bulk materials, for example fresh and flowback water from a fracking site. While the example apparatus is illustrated here for the purpose of transporting fresh and flowwater in a tank container system, it should be noted that the design may be applied to containment of a variety of bulk materials including but not limited to substances in dry form being powders, pellets, flakes, granules, or liquid form being water, chemicals, or other liquid to semi-liquid products, or gaseous products. Further, the type of containment is not limited to a tank housed on a trailer or truck frame, such as a liquid tank pump or vacuum truck, but may include but not be limited to installation of the apparatus in generally cylindrical, rectangular, trapezoidal, triangular, and/or octagonal, oval or spherical or semi-spherical storage compartments or other enclosed cargo storage spaces engineered to contain materials to be stored. These containers may be transported via truck, rail or maritime vessels. Examples of these compartments or storage spaces include but are not limited to a tank, shipping container, box trailer, bladder container, or ship hull.

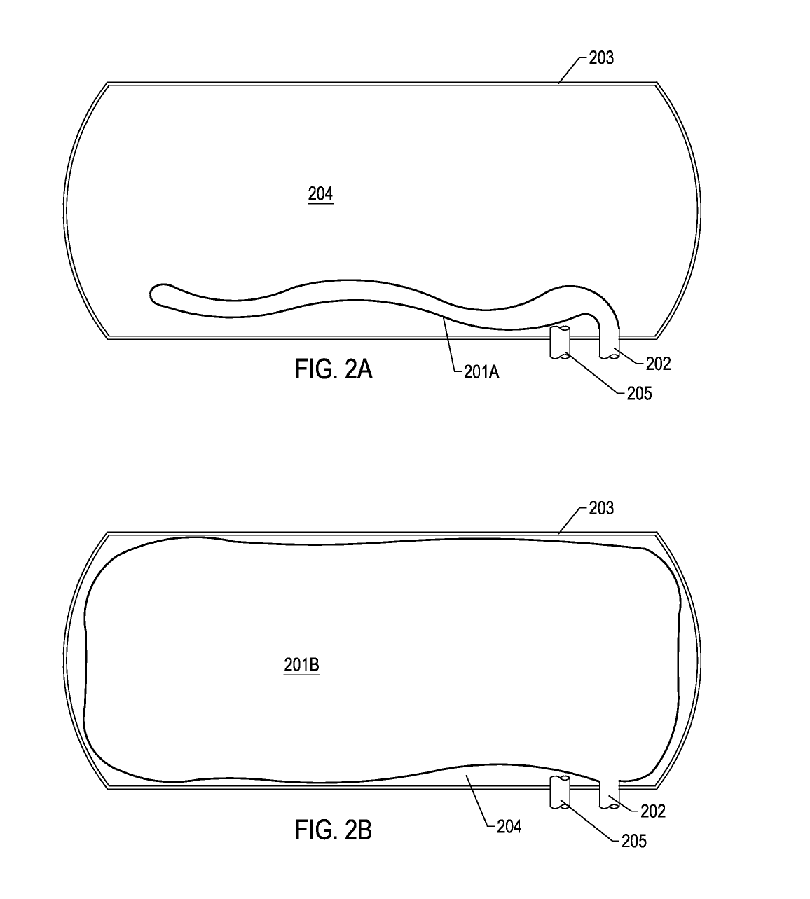

In one example, an apparatus that reduces the number of transport vehicles needed may be a bladder that can be fitted into a container or tank. As illustrated by FIG. 2A, at least one uninflated or unfilled bladder 201A, can be fitted to an inlet 202 of a container 203. The bladder 201A may be made of any flexible material durable enough to contain the product being transported. Further the material may be selected to withstand negative pressure such as that from a vacuum. These materials may include synthetic materials including polyethylenes, for example Tyvek® or Hypalon® products, polypropylenes, and/or polyvinylchlorides (PVC), natural materials including rubber, cotton, canvas, and/or a rubberized material, and synthetic and natural material blends. The material for example may be a barrier material impervious to powders, liquids, and/or gases. When the bladder 201A is uninflated or unfilled, a first bulk product can occupy the space within the tank 204 through a second inlet 205.

The bladder may be filled, either partially or fully as shown in FIG. 2B 201B, with a bulk material. In this way the bladder creates a dual use container. The bladder 201B may be mostly or completely filled such that nearly all of the interior of the container 203 is used.

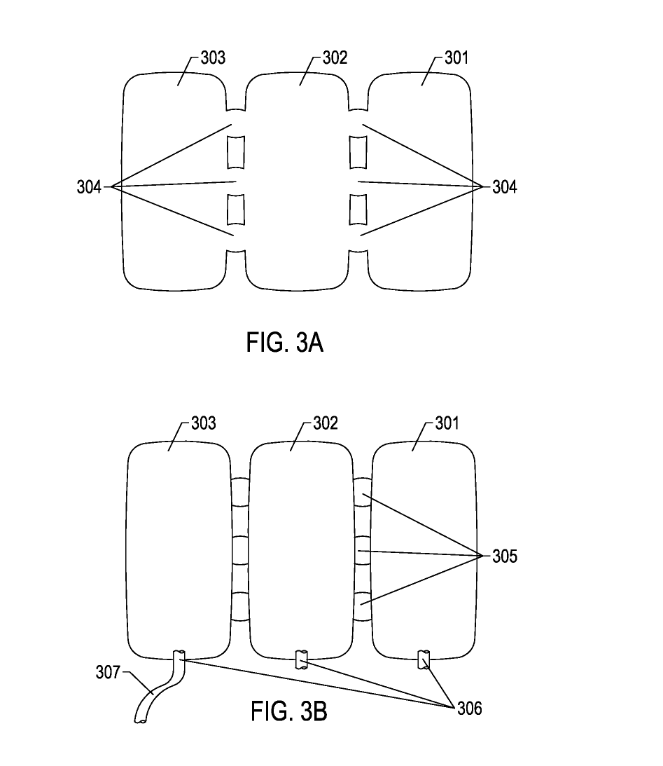

The contents of the bladder and/or the bladder itself may shift during transport causing hazards to the vehicle and driver as well as abrasion to the bladder. Alternate designs for the bladder apparatus are presented in FIGS. 3A and 3B that may alleviate this problem. As shown in FIG. 3A, the bladder may contain more than one compartment, such as at least two, or at least three compartments 301, 302, 303. These compartments 301, 302, 303 may be connected by channels 304 such that material may pass back and forth between the compartments. These channels can serve to limit flow through the bladder thereby limiting quick movement of a liquid, such as sloshing, in the event of sudden changes in speed of a transport vehicle.

Conversely, as shown in FIG. 3B, to achieve the same goal, the compartments 301, 302, 303 may be connected by a mechanical attachment means 305, such as by a strip of material that the bladder is fabricated from, that does not allow for transport between the compartments. In this instance, separate inlets for filling each compartment may be needed 306. These inlets may be integrated into the storage vessel for filling from the outside or may be connected via a hose 307 to an inlet on the storage container. It is envisioned less than all of the compartments in FIG. 3B need be filled with the bulk material to be transported. The remaining empty compartments may be filled with air or an alternate material such as water to cushion the filled compartments and prevent dramatics shifts of the bladder during transport.

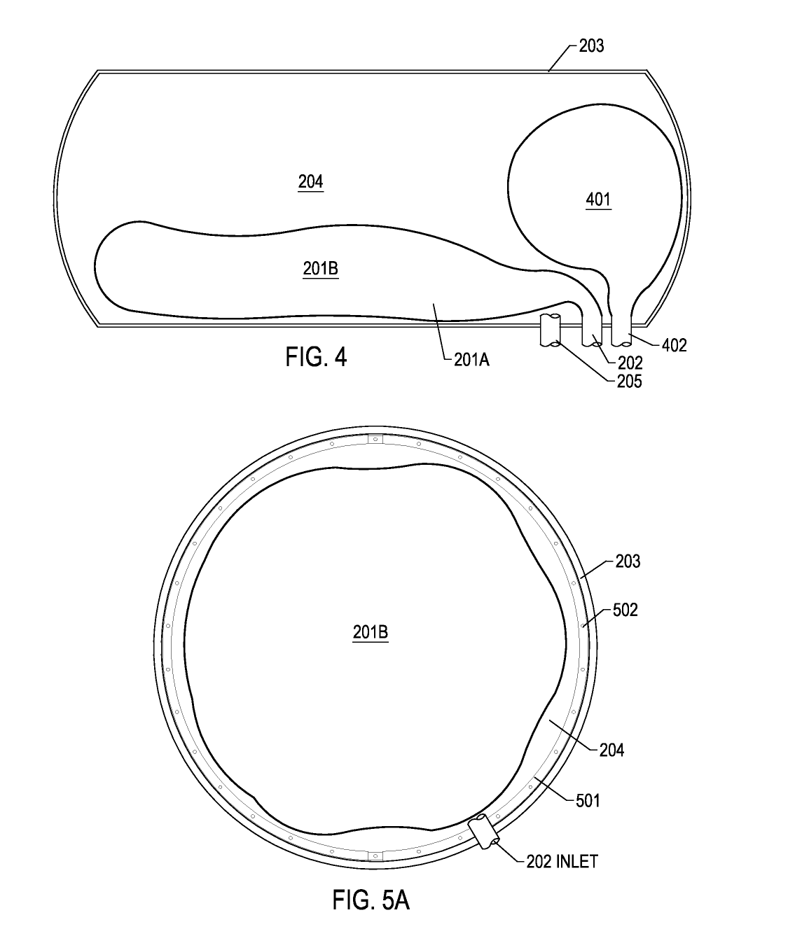

FIG. 4 illustrates an alternate design with an additional bladder to be used in conjunction with the primary bladder 201A/B. As indicated above, and is now shown in FIG. 4, a bladder 201B installed in a container 203 may be partially filled. Partial filling of the bladder leaves a large area of void 204 in the container 203. This large void area 204 leaves space for the contents of the bladder to move during transport. Large, quick movements of the contents may cause problems for the transport vehicle wherein in braking times or a turn radius for the vehicle may be increased. To prevent such movement of the transport material an additional flexible bladder 401 may be fitted to the interior of the container, with its own inlet 402. This additional bladder 401 can be filled for is example with an inert or inexpensive alternate non-target filler such as air or water. Alternately it may be envisioned that a second target transport material may be filled in the second bladder if the materials are compatible and the bladders designed appropriately.

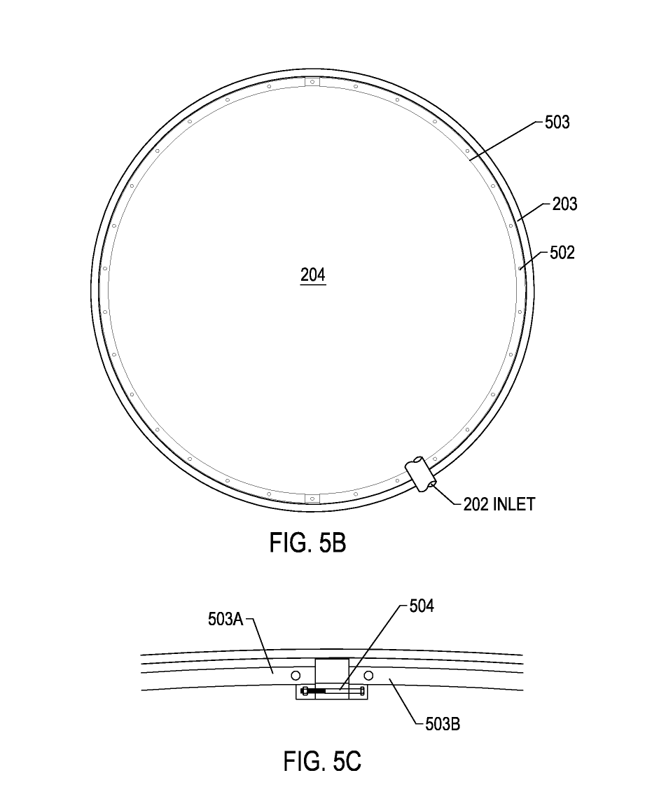

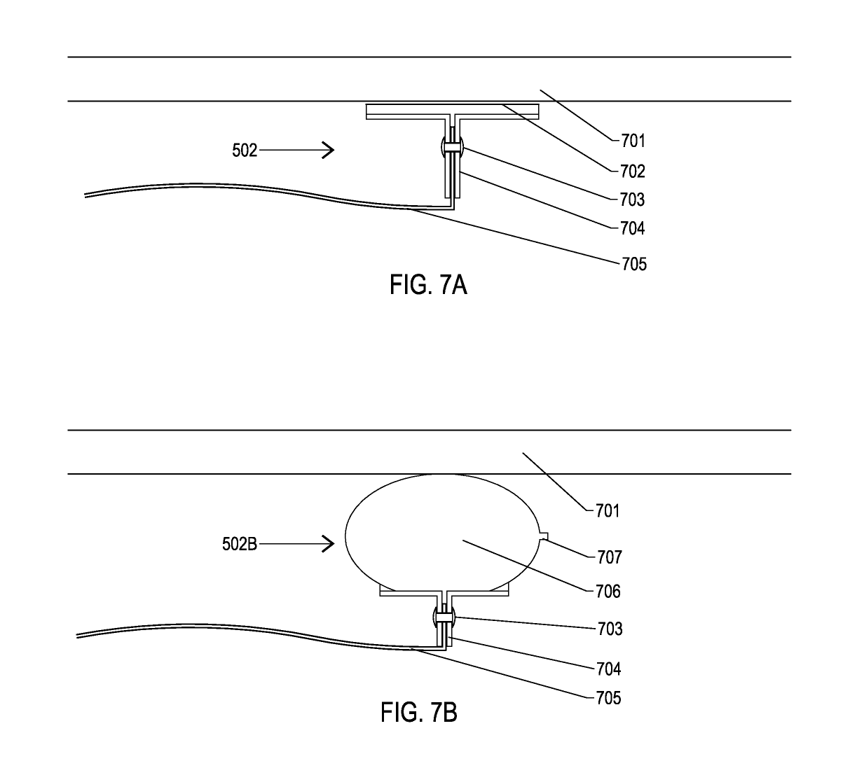

Referring to FIG. 5A, a cross section of a cylindrical container 203 is represented. Within the container, the bladder 201B, is almost completely filled, leaving little to no void space 204. To tether the bladder to the interior container walls 501, bladder holders 502 may be placed at regular or irregular intervals along the bladder. These bladder holders 502 may engage the interior wall in order to secure the bladder 201B to the interior container wall 501 or a band fitted to the interior wall as described below. The positive pressure created by filling the bladder 201B to almost or completely full may initiate engagement between one or more bladder holders 502 and the interior wall 501. These bladder holders are described in more detail in FIGS. 7A and 7B.

In another example, for instance when the interior wall of the tank or compartment may not be compatible with the bladder holders, as illustrated in FIGS. 5B and 5C, a flexible metal band 503 may be fitted within a tank. A cross section of a tank is shown with the outer wall 203 and a band 503 fitted inside. The metal band may have attachment sites for the bladder holders 502 described in FIG. 5A and in more detail in FIGS. 7A and 7B. As shown in FIG. 5C, the band 503 may be installed in the interior of the tank in pieces, such as in two, or three, or four sections. These sections 503A, 503B may be held together for example by an expansion bolt 504.

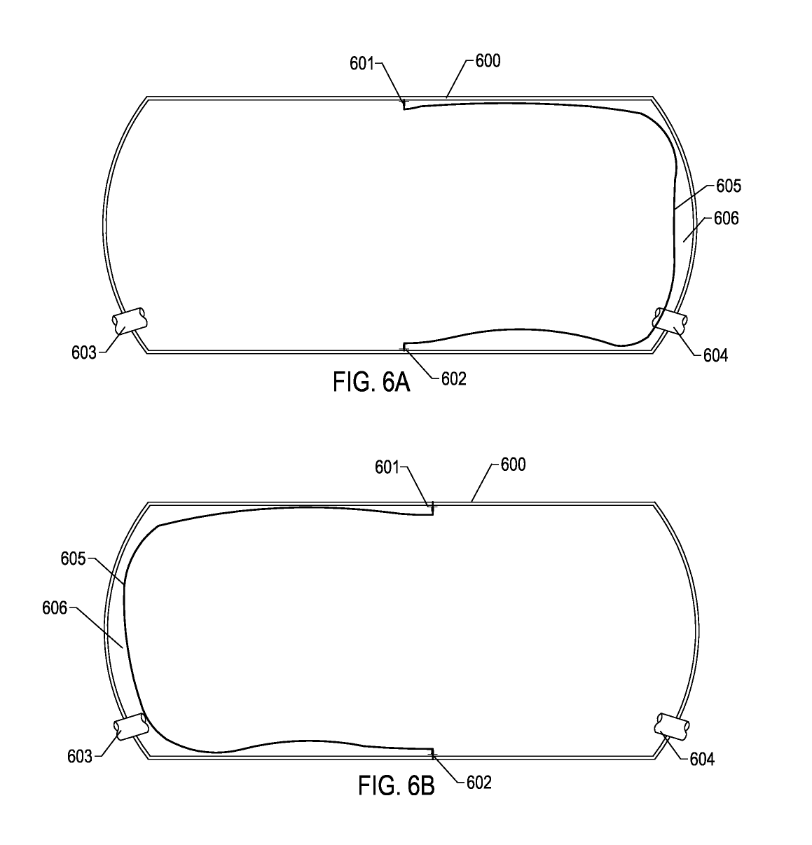

FIGS. 6A and 6B illustrate a second example bladder system. For this example bladder, the bladder is affixed at a top 601 and bottom 602 midpoint of a tank 600. In FIG. 6A, the bladder is being filled from the left side inlet 603. In FIG. 6B, the bladder is being filled from the right side inlet 604. The bladder 605 consists of a flexible material as described for the previous bladder depicted in FIG. 1 but would be attached with a seal at the top and bottom points 601 and 602. This seal would prevent contents to flow into the space 606 not filled by the bladder preventing contamination and enabling the truck to carry at least two different materials without the need for cleaning in between.

FIGS. 7A and 7B illustrate two example bladder holders 502 presented above in FIG. 5A. In FIG. 7A a portion of a cross section of a tank is shown. Adhered to the interior tank wall 701, or alternately a band fitted within the tank, as was described in FIGS. 5A, 5B, and 5C, is a compressible washer 702 that may be a rubberized or rubber-like material that is capable of being compressed. This compressible washer may be for example at least about 0.5″ in diameter, or may be at least about 1″, or at least about 2″ in diameter. Described in another way the washer may not be greater than about 6″ in diameter, or greater than about 5″ in diameter. A through bolt 703 holds an L-bracket 704 that attached to the tank bladder 705. The compressible washer holds the bladder in place via a suction and/or vacuum force.

In FIG. 7B, again a portion of a cross section of a tank is shown. Adhered to the tank wall 701, or alternately a band fitted within the tank, as was described in FIGS. 5A, 5B, and 5C, is a small bladder 706 that may be inflated through an inlet 707. The bladder may for instance at least about 1″ in diameter when inflated, or even at least about 2″ in diameter when inflated. Described another way the bladder may be not greater than about 6″ in diameter, or not greater than about 5″ in diameter when inflated. The bladder may be inflated with either compressed air or other inert gas or a liquid and/or gel. As in the above example bladder holder a through bolt 703 connects the bladder to a L-bracket 704 which is connected to the tank bladder 705.

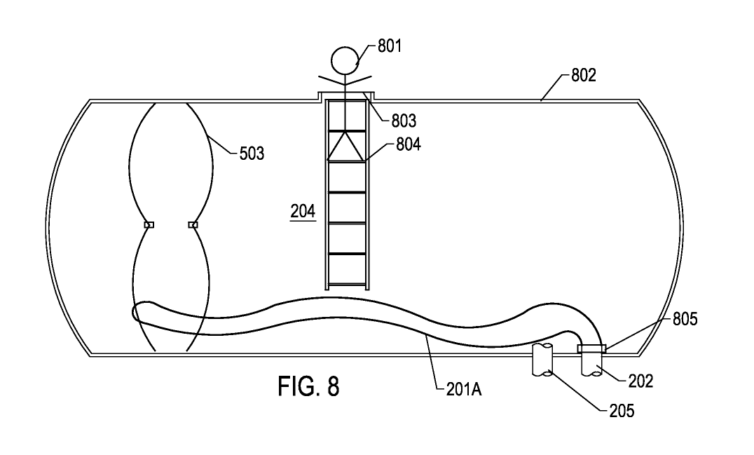

A method of installation of any of the example bladders systems is shown in FIG. 8. A person 801 having the correct training and personal protective equipment, may enter a tank 802 for example through a hole 803 in the top of the tank, descending into the tank via a ladder 804 if needed. A bladder 201A may be carried into the tank and fitted to an inlet/outlet valve 805. Alternately, a metal band 503 may be installed in sections as described in FIGS. 5B and 5C.

In another example, a method for reducing the number of transports required for bulk materials is provided. In one example, illustrated in FIG. 2A and FIG. 2B, freshwater for a fracking well could be transported to the site in the tank space 204, as in FIG. 1 101, the fresh water emptied into the well FIG. 1 102 with the sand and other chemicals. When flowwater is generated, the space within the bladder may be filled as in FIG. 2 201B with flowwater for transport to a disposal plant, as in FIG. 1 105.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

I claim:

1. A liquid transport tank comprising:
a container having a first inlet;
said container having an inner restraining surface that holds a first liquid in a void
said first liquid is input from the first inlet into the void;
said container having a second inlet connected to a bladder inside the container;
wherein imputing a second liquid into the second inlet, when the void is empty, fills either partially or fully the bladder inside the void so as to prevent the second liquid from contacting the inner restraining surface of the container.

2. The tank of claim 1, wherein the first and second inlets each serve as outlets and have a location at a bottom of the container.

3. The tank of claim 2, wherein the bladder when empty rests on the bottom of the container.

4. The tank of claim 3, wherein filling the void with the first liquid causes the first liquid to rest on the bladder on the bottom of the container.

5. The tank of claim 1, further comprising a mount on a transport vehicle.

6. The tank of claim 5, wherein the transport vehicle is a truck.

7. The tank of claim 1, wherein the bladder is made of a flexible material selected from the group consisting of polyethylene, polypropylene, polyvinylchloride, rubber, cotton, canvas and a rubberized material.

8. The tank of claim 1, wherein the bladder further comprises an anti-shifting design comprising at least two compartments, each compartment connected by a channel.

9. The tank of claim 1, wherein the bladder further comprises an anti-shifting design comprising at least two separate bladders, each bladder having a separate inlet, and a mechanical attachment between each bladder.

10. The tank of claim 1, wherein the bladder further comprises an anti-shifting design comprising at least three separate bladders, each bladder having a separate inlet, and a mechanical attachment between each bladder, and a central bladder being filled with air.

11. The tank of claim 2, wherein the container further comprises a second bladder having an inlet at the bottom of the container, and wherein filling the second bladder with a fluid fills up a portion of the void.

12. The tank of claim 2, wherein the container inner restraining surface further comprises a plurality of bladder holders which connect to the bladder and hold the bladder off the bottom of the container.

13. The tank of claim 12, wherein the container inner restraining surface further comprises a band fitted within the tank, wherein said plurality of bladder holders are mounted on the band.

14. The tank of claim 12, wherein at least one bladder holder further comprises a buffer bladder mounted on the bladder holder.

15. A liquid transport tank comprising:
a container having a first inlet located at a first end of the container, and having a second inlet locate at a second end of the container;
a bladder affixed all around an interior restraining surface of the container at a chosen location in between the first and second inlet;
wherein filling a first liquid into the first inlet causes the bladder to move into a first void in the container adjacent the second inlet, and the bladder prevents the first liquid from contacting the container interior restraining surface from the chosen location to the second inlet; and
wherein filling a second liquid into the second inlet causes the bladder to move into a second void in the container adjacent the first inlet, and the bladder prevents the second liquid from contacting the container interior restraining surface from the chosen location to the first inlet.

16. The tank of claim 15, wherein the first and second inlets are located proximate a bottom of the container, and wherein the first and second inlets also serve as outlets to empty their respective voids.

17. The tank of claim 16, wherein the chosen location is a midpoint between the first and second inlets.

18. The tank of claim 15, wherein the bladder, in a condition of a completely empty container, is suspended all along an inner periphery of the container with a portion of the bladder resting on a bottom of the container.

19. A method to transport freshwater to a fracking well and transport flowwater away from the fracking well, the method comprising the steps of:
affixing a liquid transport tank to a truck;
affixing at least one flexible bladder inside the liquid transport tank;
connecting a tank first inlet/outlet port to an inlet of the bladder;
filling the liquid transport tank with freshwater from a second inlet/outlet port of the tank;
driving the truck to a fracking well and unloading the freshwater;
filling the liquid transport tank with flowwater using the first inlet/outlet port, thereby filling the bladder inside the liquid transport tank; and
driving the truck to a site remote from the fracking well and unloading the flowwater.

20. The method of claim 19, further comprising the step of locating the first inlet/outlet port and the second inlet/outlet port at a bottom of the tank.
